(19) United States
(12) Patent Application Publication
(10) Pub. No.: US 2011/0108577 A1
(43) Pub. Date: May 12, 2011

(54) DEVICE FOR STORING, SELECTING AND DISPENSING A PLURALITY OF PRODUCTS, SUCH AS A SERIES OF BASE COLOURS FOR AUTOMOTIVE PAINT

(76) Inventor: Antoine Chassaing, Clevilliers (FR)

(21) Appl. No.: 12/737,396

(22) PCT Filed: Jul. 10, 2009
(86) PCT No.: PCT/FR2009/051379

§ 371 Date: Jan. 7, 2011

(30) Foreign Application Priority Data
Jul. 16, 2008 (EP) 08290695.9

(51) Int. Cl. B67D 7/78; B67D 7/06

(52) U.S. Cl. 222/144; 222/144.5

(57) ABSTRACT

The device comprises a carrousel having a horizontal axis with a plurality of containers, each suitable for receiving a respective one of the compositions. The containers are disposed in a circumferential configuration and they are assembled in succession one after another so as to form a self-supporting single-piece ring. Each container includes means for securing it on either side to the contiguous containers situated around the circumference of the ring. To support the ring, the device includes a semicircular monorail extending relative to the ring in a radial plane, the containers including respective guide members and support members suitable for resting on the monorail.

### FIELD OF THE INVENTION

The invention relates to a device for storing, selecting, and dispensing a plurality of compositions, in particular a series of base colors for automotive paint.

### BACKGROUND OF THE INVENTION

In this field, body repairers make up the quantities of paint needed for repairing bodywork by mixing a certain number of base colors. Each mixture is determined from a formula defined by the paint manufacturer and specifying the weights of each of the base colors to be incorporated for a given quantity of mixture to be obtained. Such preparation commonly involves mixing five to ten base colors in order to obtain the particular shade specified by the paint manufacturer.

Away from the field of automotive repair, dispensers are known for selecting and mixing base colors, e.g. a device as described in U.S. Pat. No. 3,074,597 B1 (Felts) for preparing paint for use in building, where pigments are added to a white paint in order to obtain a particular color, on demand. The device described in that document comprises a carrousel having a rotary element with a horizontal axis with various tanks storing the base colors being mounted thereon in a radial configuration. That rotary element is actuated so as to bring such and such a tank into an extraction position, from which a desired quantity of pigment is ejected into a collector receiver under the action of a piston incorporated in the tank.

In the field of cosmetics, WO 03/0264582 A2 (IMX Labs, Inc.) describes a device presenting the same general configuration as above and serving at points of sale close to consumers, to prepare, on demand cosmetics such as nail varnishes.

The first drawback of all those devices is their great mechanical complexity, which has the immediate consequence of making them expensive to manufacture, thus constituting an obstacle to widespread use.

Thus, in the field of automotive paints, it would be advantageous to be in a position to make available, even to small body repair businesses, an appliance that serves to prepare on demand small quantities of paint from a plurality of colors selected from a relatively large range of base colors that are stored in appropriate individual containers, typically a range of fifty to sixty different colors.

Another drawback of prior art devices stems from the fact that they include numerous visible mechanisms that are exposed to all kinds of pollution. In an industrial environment, there thus exists a particularly high risk of the delicate mechanism of the dispenser carrousel being dirtied, which may well prevent it from operating correctly.

Yet another drawback is that such devices require lengthy and difficult disassembly, in particular during maintenance and cleaning operations, where cleaning is made that much more necessary by the appliance being installed in a polluting environment.

Finally, if it is desired to increase the number of compositions (e.g. the number of base colors) that are stored simultaneously in a single device, that leads to a very large increase in its size. Unfortunately, not only does a large size go against obtaining desirable compactness, but also, as a result of the corresponding increase in the weight of the assembly (appliance proper together with the stored compositions), it becomes necessary from a mechanical point of view to reinforce and stiffen the various support and guide elements in order to enable the carrousel to be driven and indexed accurately when selecting the compositions.

### Object and Summary of the Invention

An object of the invention is to remedy all of the above-mentioned drawbacks encountered with prior art devices.

The device of the invention is of the general type as disclosed in above-mentioned U.S. Pat. No. 3,074,597 B1, i.e. comprising a carrousel having a horizontal axis with a plurality of containers, each suitable for receiving a respective one of said compositions, the containers being disposed in a circumferential configuration.

In a manner characteristic of the invention, the containers are assembled in succession to one another so as to form a one-piece ring, and each container includes link means suitable for securing it on either side to the contiguous containers situated around the circumference of the ring. The device also includes ring support means suitable for providing the ring with one degree of freedom to move in rotation about said horizontal axis.

The ring is advantageously a self-supporting ring having no additional stiffening reinforcement.

The support means of the ring may in particular comprise a semicircular monorail extending relative to the ring in a radial plane, at least some of the containers including respective guide members and support members suitable for resting on said monorail.

In this configuration, and in preferred manner:
the semicircular monorail extends in the vicinity of the inside periphery of the ring and in a top region of said periphery, in such a manner as to support the ring in a configuration in which it is suspended from the monorail;
said guide member comprises a wall formed in an inner end region of the container, said wall extending in a radial direction towards the inside of the ring and projecting in said direction relative to the support member; and
said support member comprises a wheel mounted loose on the container at an inside end region thereof.

Advantageously, the device also includes motor means suitable for driving the ring in rotation about said horizontal axis, at least some of the containers including a drive member suitable for co-operating with said motor means. Said drive member may then comprise a rack formed on the container in an inside end region thereof.

Said means for linking each container to the contiguous containers may in particular comprise fitted link pieces and fastener means for fastening the link pieces to the containers, the link pieces being fastened in an outside end region of the containers.

The device comprises N series (N≦2) of containers that are assembled together so as to form N respective rings, these rings being stacked one against another along a common horizontal axis.

In this configuration, in preferred manner:
the link means of each container are suitable for securing it firstly to the adjacent containers situated around the circumference of the ring to which the container belongs, and secondly to the adjacent containers situated in the contiguous ring;
the N rings are mutually offset circumferentially by 1/N of their pitch; and
the device has N=2 rings and the support means comprise a semicircular monorail extending in a radial plane, the monorail being common to the two rings, and at least some of the containers including respective guide members and support members suitable for resting on said common monorail.

Each container may be in the form of a flat goblet comprising: two plane walls extending in axial planes relative to said horizontal axis and suitable for coming into contact with a facing plane wall of a contiguous goblet; two side walls interconnecting said plane walls; and a goblet end wall interconnecting the plane walls and the side walls in an inside end region of the goblet. In this way, the inside volume of the goblet defines a socket open towards the outside of the ring and suitable for receiving in leaktight manner removable packaging containing one of said compositions, said container including the socket and the associated pouch.

Each goblet may in particular be suitable for housing a removable flexible pouch containing one of said compositions and provided with a composition dispenser member. The end wall of the goblet includes an orifice allowing said dispenser member of the pouch inserted in the goblet to pass through said end wall so that said dispenser member projects out from the goblet so as to be accessible on the inside of the ring.

### BRIEF DESCRIPTION OF THE DRAWINGS

There follows a description of an embodiment of the device of the invention given with reference to the accompanying drawings in which the same numerical references are used from one figure to another to designate elements that are identical or functionally similar.

FIG. 1 is a general elevation view of a device of the invention comprising a rotary carrousel with a ring of containers that are assembled together, each housing one of the compositions for storing and dispensing, e.g. packaged in the form of flexible pouches, each filled with a different base color.

FIG. 2 is a perspective view of the FIG. 1 device with the ring of containers partially cut away.

FIG. 3 is a view showing in isolation one of the containers in the form of a box.

FIG. 4 shows the FIG. 3 container provided with various means for supporting it and assembling it to the adjacent containers.

FIG. 5 is a partially cutaway perspective view showing two stacked rings of containers being assembled, in order to illustrate how such assembly is performed.

FIG. 6 is a fragmentary view in perspective of the device of FIGS. 1 and 2, showing in particular the means for driving the ring of containers in rotation.

### MORE DETAILED DESCRIPTION

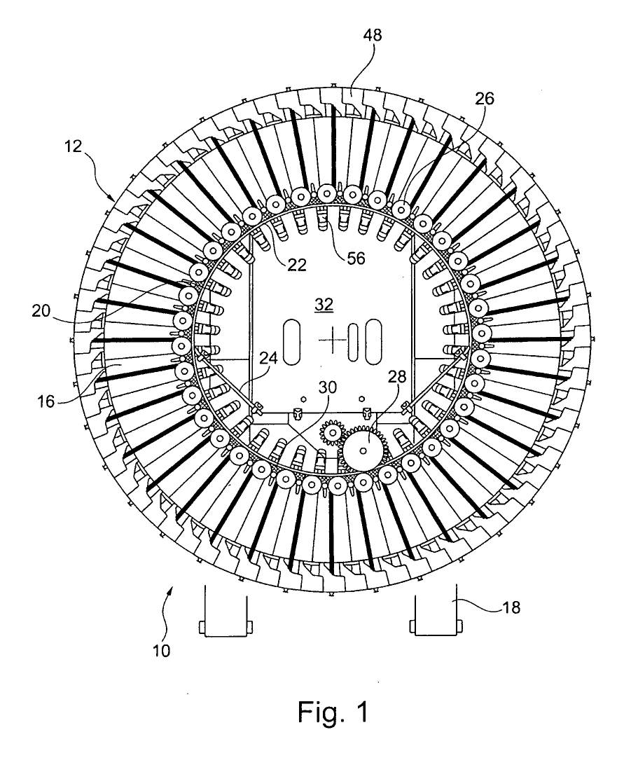

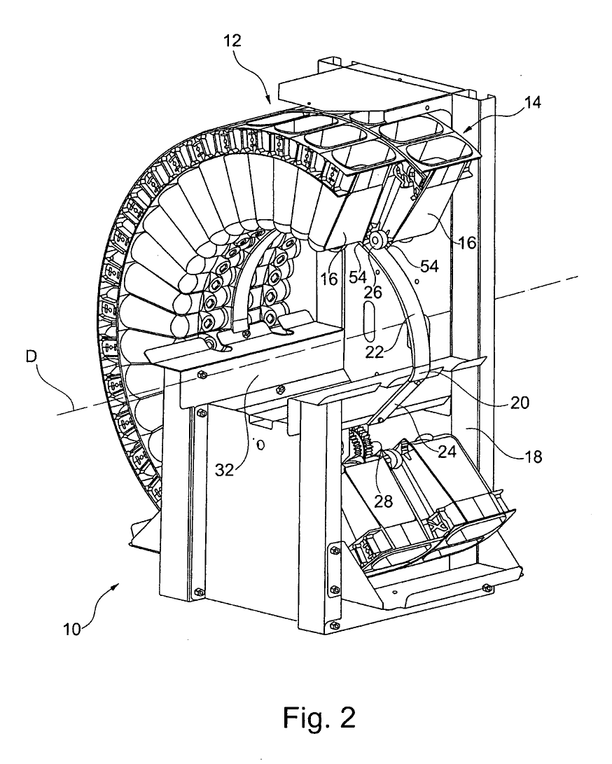

In FIGS. 1 and 2, reference 10 is an overall reference for a device of the invention for storing, selecting, and measuring out a certain number of compositions contained in independent containers, e.g. base colors for automotive paint—this application naturally not being limiting in any way.

In particular, it may comprise a particular embodiment of the device described in patent application EP 08 290588.6 filed Jun. 20, 2008 and entitled “Device for storing, selecting and dispensing base colors for paint, in particular for automotive paint”, in the name of Fillon Technologies.

The device 10 of the invention comprises one or more rings, there being two rings 12 and 14 stacked one against the other in the example shown, each ring being constituted by assembling individual containers 16 together.

The containers 16 are assembled in the manner that is explained in detail below so as to form a one-piece ring, each container being secured to the adjacent containers situated around the circumference of the same ring 12 or 14.

In addition, in the configuration shown that has two stacked rings 12 and 14, the containers of one of the rings 12 are secured to the containers of the other ring 14, with the assembly forming a double one-piece ring that is self-supporting and that does not include additional stiffener elements.

The two rings are advantageously offset by one-half of their pitch in the manner and for the reasons that are explained below.

It is thus possible without difficulty to make an assembly, as shown, that comprises 2×36=72 containers distributed in two adjacent rings and suitable for storing as many different compositions, e.g. as many base colors for fabricating paints on demand.

The device 10 includes a stand 18 having mounted thereon the assembly constituted by the two rings 12 and 14, this assembly being supported with one degree of freedom to move in rotation about a horizontal axis D so as to constitute a carrousel for selecting and dispensing compositions contained in the various containers 16.

The rings 12 and 14 are advantageously carried by a monorail 20 extending in a middle radial plane relative to the assembly formed by the two rings. The monorail 20 comprises a free semicircular portion 22 extending over approximately 180° and extended at both ends by inwardly-directed portions 24 secured to the stand 18. The monorail 20 thus extends over about a semicircle, and is secured to the stand solely by the portions 24 extending the semicircular free portion 22.

The monorail 20 serves to support the rings 12 and 14 via wheels 26 mounted to rotate on the various containers 16 making up the rings.

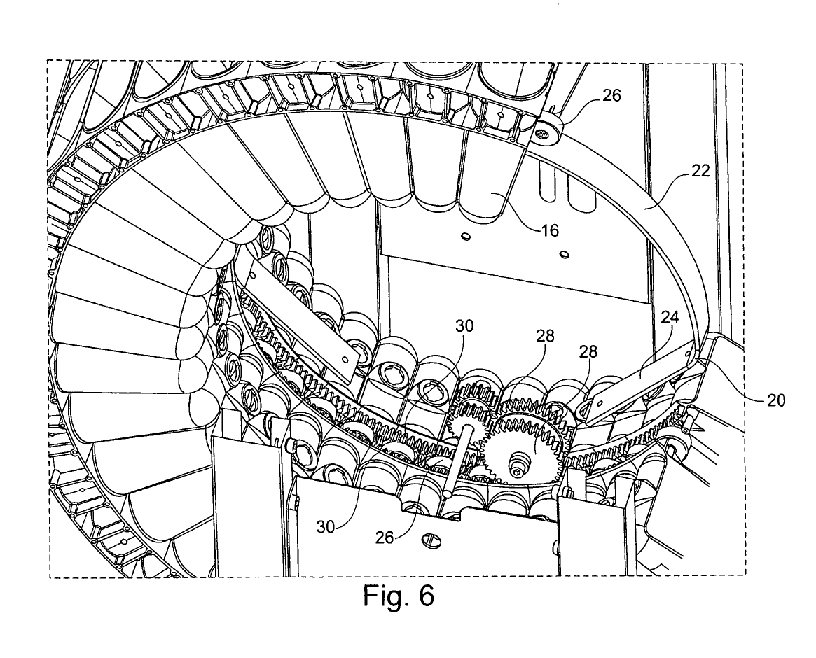

The device also includes drive means such as a motor-driven pinion 28 that meshes with respective racks 30 formed on each of the rings. The racks 30 of each of the rings can be seen, in particular in FIG. 6, extending on either side of the row of support wheels 26, each rack 30 meshing with a pinion 28 that is connected by an appropriate gear mechanism to a drive motor (not shown) of the device.

This configuration of support by means of a semicircular monorail enables the central space 32 situated at the center of the ring to be left empty, e.g. in order to enable a collector receiver (not shown) to be placed therein.

The carrousel is then driven in rotation by appropriate manual or automatic indexing means enabling one of the containers 16 in one ring or the other to be placed facing the collector receiver so as to enable it to receive the particular color stored in the container as selected in this way.

Nevertheless, this configuration is not limiting. The collector receiver could for example be disposed laterally, with an expulsion system being provided to cause the color stored in the selected container brought into register therewith to be directed in the appropriate direction by means of a pipe-bend member.

In the same manner, instead of being situated at the center of the carrousel as in the example shown, the collector receiver could equally well be placed beneath it, with the composition stored in the container then being delivered radially outwards instead of radially inwards.

Finally, it should be observed that the radial configuration of the example described is not limiting, and that the main direction of the containers making up the various rings could extend in a direction other than radial (e.g. in a horizontal direction), providing the axis of rotation D of the carrousel is a horizontal axis.

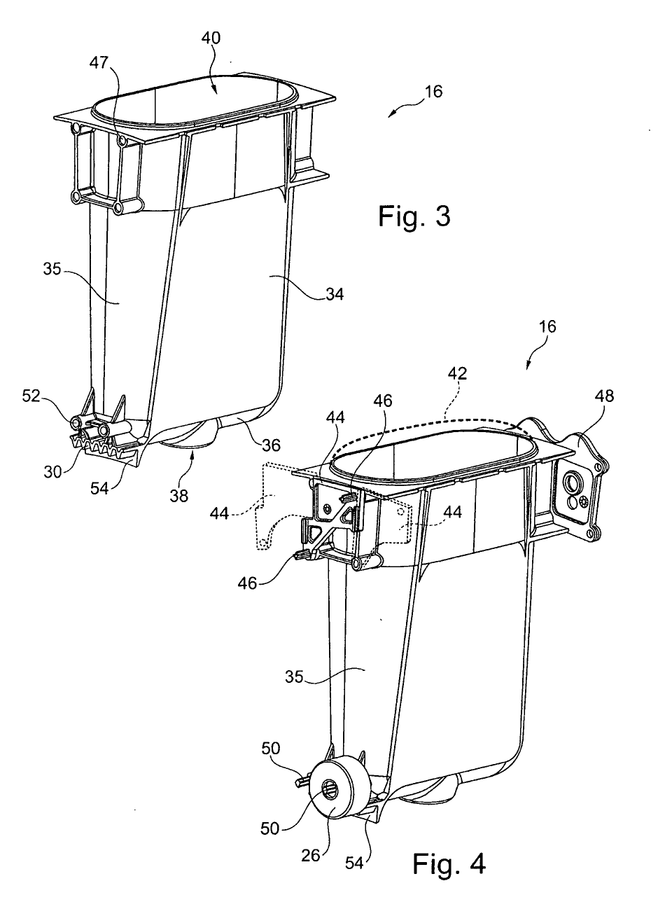

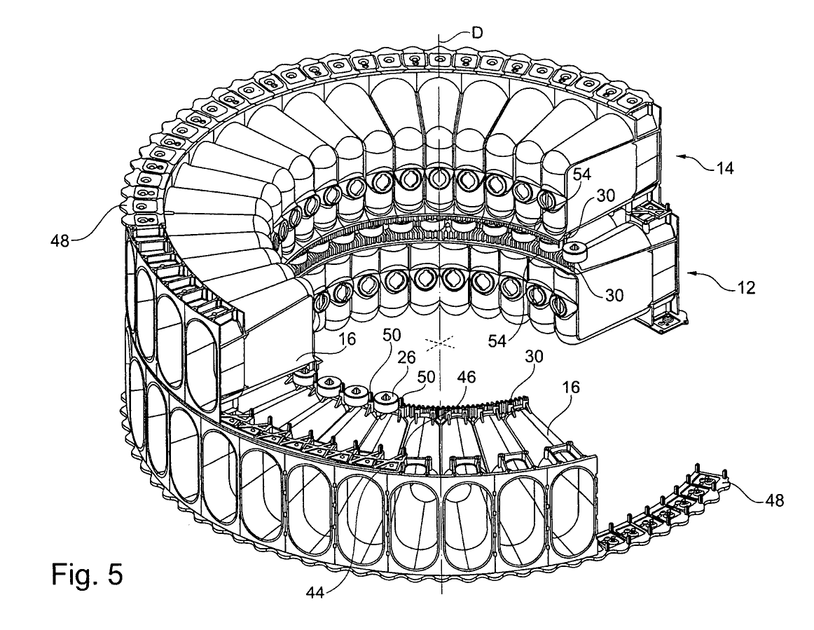

FIGS. 3 and 4 show in isolation one of the containers 16 making up the rings 12 or 14, and FIG. 5 shows how the containers are assembled together to form these two stacked rings.

All of the containers 16 are identical and made in the form of flat goblets having two substantially plane walls 34 enabling each goblet to be placed against the adjacent goblet of the ring. The plane walls 34 are connected together by lateral walls 35.

In an inner end region (i.e. a region directed towards the center of the ring), the goblet includes a bottom wall 36 with a central orifice 38.

In its opposite outer end region, the goblet presents an opening 40 suitable for being closed in leaktight manner by a lid 42.

This configuration enables the container 16 in the form of a rigid goblet to receive internally a single-use removable flexible pouch having one of the base colors stored therein. Such a pouch may be provided with a valve, e.g. the valve described in patent application EP 07 290369.3 filed on Mar. 28, 2007 and entitled “Dispensing valve”, in the name of Fillon Technologies, suitable for being mounted on the flexible pouch by a quick-coupling such as that described in patent application EP 08 290235.4 filed on Mar. 12, 2008 entitled “An assembly of the quick-coupling type for liquids, in particular for a flexible pouch container”, in the name of Fillon Technologies.

The flexible pouch with its valve is inserted into the container 16 via the opening 40, the valve projecting from the container 16 through the orifice 38 (as can be seen in particular in FIG. 1), where reference 56 designates the valve of the pouch stored in the container 16).

Nevertheless, this embodiment is not limiting in any way and other modes of storage are possible: by way of example, the composition may be stored directly in the container 16, or on the contrary it may be stored in a cartridge that is rigid or semirigid and that constitutes outer packaging, itself containing a flexible pouch. The invention relates to how the containers 16 are assembled to one another so as to form one or more self-supporting rings, and not to the manner in which the containers are used for storing compositions that are to be dispensed, whether they be base colors for paints or compositions of some other kind.

The various containers 16 are assembled together by link pieces 44 carrying pegs 46 that are inserted in complementary sockets 47 of adjacent containers. These link pieces 44 are placed against the side face 35 that is adjacent to the midplane of the assembly formed by the two rings, so as to assemble together not only the adjacent containers 16 in a given ring, but also to assemble these containers to the containers situated facing them in the adjacent ring (offset by one-half of their pitch). It should be observed that the link piece 44 may optionally act as a hinge or a catch for the lid 42, thus avoiding the need to fit an additional element to hinge the lid.

On the opposite side wall, i.e. on the side wall situated beside the free side of the assembly formed by the two rings, the link pieces 48 are in the form of label carriers, thereby enabling the content of each of the corresponding containers to be identified in a manner that its immediately apparent for a user facing the device.

In the inner end region of the side wall 35, pieces in the form of a pair of pegs 50 are inserted into corresponding orifices 52 formed in the side wall 35. These two pegs 50 serve to connect together the containers 16 of the two adjacent rings, thus securing the containers together in the region of the inner periphery of the ring.

In addition, the pegs 50 may be used for supporting the wheels 26, e.g. one wheel for every other container so as to leave sufficient space between two consecutive wheels in this region of the ring.

The side wall 35 of each container 16 is also provided, in its inner end region, with a portion of a rack 30 for driving the ring in rotation, and also with a wall 54 facing towards the inside and projecting radially over a distance that is greater than the size of the teeth in the rack 30. As can be seen in particular in FIG. 2, when the two rings 12 and 14 are assembled together, the walls 54 of the respective containers 16 in the two rings occupy positions on either side of the monorail 22 and thus serve to guide the rings on the monorail by preventing any axial movement (parallel to the axis D). The assembly formed by the two rings 12 and 14 is thus constrained to have a single degree of freedom to move in rotation, and has no freedom to move axially.

FIG. 5 shows how the containers 16, which are advantageously all identical and made of a molded plastics material, are assembled together so as to form a one-piece and self-supporting assembly, constituted by two stacked rings 12 and 14.

The first step, shown in the bottom right-hand portion of FIG. 5 consists in assembling a first row of containers 16 using a first series of label carriers 48 situated axially on the outside of the ring. The containers are then united on the opposite side (i.e. beside the middle radial plane that is to be formed by the two rings) by means of the link pieces 44 having their pegs 46 in the outer end region, and by means of the pairs of pegs 50 in the inner end region.

The wheels 26 are then mounted on the pegs 50, and then a second row of bare containers 16 is assembled on the first row so as to make up the second ring 14. The containers of the second row are assembled by being engaged on the pegs 46 and 50 that are already secured to the containers of the first row. Finally, the containers of the second row are connected to one another in the outer end region by means of a second series of label carriers 48 engaged on the free face of the second ring 14.

The assembly constituted by the two rings 12 and 14 may then be installed directly on the support monorail 22, with this installation (or indeed removal) not requiring any complex mechanical operation, insofar as the rings are merely placed on the monorail that supports them in a disposition in which they are suspended therefrom.

This configuration also presents the advantage of providing the assembly with good flexibility, making it possible to accommodate sufficient clearance to ensure the device operates properly. The rings, which do not include any fitted stiffening elements, are slightly deformable, in particular when the containers are full, and it is important to avoid any risk of these rings becoming blocked or jammed while they are rotating.

The fact that the guide and support system (guidance via the walls 34, support via the wheels 26) is integrated in the rings also contributes to the assembly fitting well and to having good flexibility with accommodation for any deformation and clearance.

Yet another advantage of this configuration is the fact that since the ring is suspended, it is not only easy to remove, but it is also more compact, since all of its essential members are situated not at the periphery of the ring (assuming that the ring is supported and not suspended), but in the region inside the ring: semicircular monorail 22, fastenings 24 between the monorail and the stand 18, drive system including the pinions 28, and space 32 for placing a collector receiver.

It should also be observed that this configuration is particularly well adapted to polluting environments such as those in engine or body shops, insofar as only a minimum number of portions that are sensitive to dirtying are visibly exposed. In particular, the rack and the drive mechanism are exposed very little, and the outside of the ring does not include any mechanical elements. It should be observed in particular that in the visible top region corresponding to the semicircular portion of the monorail 22, the rack is completely hidden by the monorail thus avoiding any risk of external pollution by dust, splashes, etc. As for the bottom region, the rack may be protected by mounting a suitable cover on the stand 16, as shown in FIG. 2, with the same applying to the drive mechanism 28, the cover being easily removable in order to be able to extract the ring by separating it from the monorail 22.

Finally, concerning the cost price of the device, this can be reduced to a very large extent, even with a high capacity device, given the technological simplicity with which such a device can be made:
containers made as molded goblets;
no internal element such as a support rim;
no stiffener element for the ring, which is in the form of a self-supporting single piece; and
very small number of different parts needed for making up the ring.

What is claimed is:

1. A device for storing, selecting, and dispensing a plurality of compositions, in particular a series of base colors for automotive paint, the device comprising a carrousel having a horizontal axis with a plurality of containers each suitable for receiving a respective one of said compositions, the containers being disposed in a circumferential configuration, wherein:
the containers are assembled in succession one after another so as to form a one-piece ring, each container including link means suitable for securing it on either side to the contiguous containers situated around the circumference of the ring; and
the device includes support means for the ring, suitable for providing the ring with one degree of freedom to move in rotation about said horizontal axis.

2. The device of claim 1, wherein the ring is a self-supporting ring having no additional stiffening reinforcement.

3. The device of claim 1, wherein the support means of the ring comprise a semicircular monorail extending relative to the ring in a radial plane, at least some of the containers including respective guide members and support members suitable for resting on said monorail.

4. The device of claim 3, wherein the semicircular monorail extends in the vicinity of the inside periphery of the ring and in a top region of said periphery, in such a manner as to support the ring in a configuration in which it is suspended from the monorail.

5. The device of claim 3, wherein said guide member comprises a wall formed in an inner end region of the container, said wall extending in a radial direction towards the inside of the ring and projecting in said direction relative to the support member.

6. The device of claim 3, wherein said support member comprises a wheel mounted loose on the container at an inside end region thereof.

7. The device of claim 1, wherein the device also includes motor means suitable for driving the ring in rotation about said horizontal axis, at least some of the containers including a drive member suitable for co-operating with said motor means.

8. The device of claim 7, wherein said drive member comprises a rack formed on the container in an inside end region thereof.

9. The device of claim 1, wherein said means for linking each container to the contiguous containers comprise fitted link pieces and fastener means for fastening the link pieces to the containers, the link pieces being fastened in an outside end region of the containers.

10. The device of claim 1, wherein the device comprises N series of containers, where N≧2, that are assembled together so as to form N respective rings, these rings being stacked one against another along a common horizontal axis.

11. The device of claim 10, wherein the link means of each container are suitable for securing it firstly to the adjacent containers situated around the circumference of the ring to which the container belongs, and secondly to the adjacent containers situated in the contiguous ring.

12. The device of claim 10, wherein the N rings are mutually offset circumferentially by 1/N of their pitch.

13. The device of claim 10, wherein the device has N=2 rings and the support means comprise a semicircular monorail extending in a radial plane, the monorail being common to the two rings, and at least some of the containers including respective guide members and support members suitable for resting on said common monorail.

14. The device of claim 1, wherein each container is in the form of a flat goblet comprising:
two plane walls extending in axial planes relative to said horizontal axis and suitable for coming into contact with a facing plane wall of a contiguous goblet;
two side walls interconnecting said plane walls; and
a goblet end wall interconnecting the plane walls and the side walls in an inside end region of the goblet;
in such a manner that the inside volume of the goblet defines a socket open towards the outside of the ring and suitable for receiving in leaktight manner removable packaging containing one of said compositions, said container including the socket and the associated pouch.

15. The device of claim 14, wherein each goblet is suitable for housing a removable flexible pouch containing one of said compositions and provided with a composition dispenser member, and wherein the end wall of the goblet includes an orifice allowing said dispenser member of the pouch inserted in the goblet to pass through said end wall so that said dispenser member projects out from the goblet so as to be accessible on the inside of the ring.
